(19) United States
(12) Patent Application Publication
(10) Pub. No.: US 2008/0014486 A1
(43) Pub. Date: Jan. 17, 2008

(54) Fuel Cell

(76) Inventors: Shigeyuki Unoki, Osaka (JP); Shinsuke Takeguchi, Osaka (JP); Yasuo Takebe, Kyoto (JP)

Correspondence Address: MCDERMOTT WILL & EMERY LLP, 600 13TH STREET, NW, WASHINGTON, DC, 20005-3096, US

(21) Appl. No.: 11/791,493

(22) PCT Filed: Nov. 8, 2005
(86) PCT No.: PCT/JP05/20445

§ 371 Date: May 24, 2007

(30) Foreign Application Priority Data
Nov. 24, 2004 (JP) 2004-339527

(51) Int. Cl. H01M 8/04; H01M 2/18; H01M 8/10

(52) U.S. Cl. 429/26

(57) ABSTRACT

The temperature of cooling fluid in an inlet side manifold is increased during power generation by influence of the temperature of heat generation sections of cells. This causes variation in temperature among unit cells in a fuel cell stack, causing flooding and variation in output voltage. The invention provides a fuel cell in which an increase in temperature of cooling fluid in an inlet side manifold is suppressed, and that has an excellent durability and a stable output voltage. The fuel cell has flow paths for cooling fluid in cathode side separator plates and anode side separator plates, the flow paths connecting an inlet side manifold and an outlet side manifold for cooling fluid. Each of the flow paths for cooling fluid includes a first cooling section for cooling a heat generation section, that is, an area corresponding to a cathode or an anode, and a second cooling section located between the first cooling section and the inlet side manifold for cooling fluid.

### TECHNICAL FIELD

The present invention relates to fuel cells for use in domestic cogeneration systems, motorbikes, electric cars, hybrid electric cars and the like, and in particular to polymer electrolyte fuel cells. More specifically, the present invention relates to fuel cells excellent in durability in which flooding hardly occurs because of reduced variation in temperature among the unit cells in the cell stack of the fuel cells.

### BACKGROUND ART

In fuel cells using a polymer electrolyte having cation (hydrogen ion) conductivity, electric power and heat are generated simultaneously through electrochemical reactions of a fuel gas containing hydrogen and an oxidant gas containing oxygen, such as air. The fuel cell basically includes a polymer electrolyte membrane having hydrogen ion conductivity that selectively transports hydrogen ions, and a pair of electrodes disposed on both faces of the polymer electrolyte membrane. Each of the electrodes has a gas diffusion electrode comprising a catalyst layer mainly composed of conductive carbon powder carrying an electrode catalyst (for example, a metal catalyst such as platinum) and a gas diffusion layer having both gas permeability and electron conductivity (for example, carbon paper subjected to water repellent treatment) and being formed outside the catalyst layer. This is called a membrane electrode assembly (MEA).

In order to prevent leakage of the supplied fuel gas and oxidant gas (reaction gas) to the outside or mixing of the two gases, gas sealing members or gaskets are arranged on respective outer circumferences of the electrodes sandwiching the polymer electrolyte membrane. The sealing members or the gaskets are integrated beforehand with the electrodes and the polymer electrolyte membrane to give an assembly. Conductive separator plates are disposed outside the MEA to mechanically fix the MEA and to electrically connect adjoining MEAs with one another in series. Gas flow paths, through which reaction gases are supplied to the electrodes and a produced gas and excess gases are carried out, are formed in specific parts of the separator plates that are in contact with the MEA. Although, the gas flow path may be provided independently of the separator plate, the gas flow path is typically formed by a groove provided on the surface of the separator plate.

In a general structure of a laminated cell, these MEAs and separator plates are alternately stacked to form a stack of 10 to 200 cells, and the resultant stack is sandwiched by end plates with a current collector plate and an insulating plate interposed therebetween and is clamped with clamping bolts from both sides. This is called a cell stack.

The polymer electrolyte membrane is impregnated with moisture in a saturated state, and thus the specific resistance of the membrane is reduced. This allows the polymer electrolyte membrane to function as an electrolyte having hydrogen ion conductivity. For this reason, during the operation of the fuel cell, a fuel gas and an oxidant gas are humidified during their supply in order to prevent the moisture from being evaporated from the polymer electrolyte membrane. Moreover, during power generation of the fuel cell, the following electrochemical reactions occur and water is produced as a reaction product at cathode side.
Anode: H₂→2H⁺+2e⁻ (1)
Cathode: 2H⁺+(½)O₂+2e⁻→H₂O (2)

The water in the humidified fuel gas, the water in the humidified oxidant gas and the water as a reaction product are used for keeping the water content in the polymer electrolyte membrane in a saturated state, and thereafter discharged to the outside of the fuel cell with the excess fuel gas and oxidant gas.

Further, since the reactions above are exothermic reaction, it is necessary to cool the cell stack during power generation of the fuel cell. A general method for cooling the cell stack is to form a flow path for cooling fluid (for example, cooling water) on a plane (a second plane) of the separator plate in the opposite side of a plane (a first plane) that is in contact with the MEA, and to allow a cooling fluid to flow therethrough to cause thermal exchange between the separator plate, the temperature of which is increased because of the exothermic reactions, and the cooling fluid. Although the flow path for cooling fluid may be provided independently of the separator plate, the flow path is typically formed by a groove provided on the surface of the separator plate.

When the cell stack is not cooled sufficiently, the temperature of the MEA is raised and the moisture is evaporated from the polymer electrolyte membrane. As a result, the degradation of the polymer electrolyte membrane is accelerated to shorten the durability of the cell stack or the specific resistance of the polymer electrolyte membrane is increased to lower the output of the cell stack. On the other hand, when the cell stack is cooled more than necessary, the moisture in the reaction gas that is flowing in the gas flow path is condensed and the amount of water in a liquid state contained in the reaction gas is increased. The water in a liquid state adheres onto the gas flow path in the separator plate as liquid drops because of its surface tension. When the amount of the liquid drops is great, the water adhering onto the inside of the gas flow path clogs the gas flow path to inhibit the flow of gas, eventually causing flooding. This consequently decreases the reaction area inside the electrode, resulting in reduction in battery performance.

In view of the above, for the purpose of cooling better an area in a flow path for oxidant gas where the water content is small, there has been proposed a cooling method in which the area in the flow path for oxidant gas where the water content is small, that is, an inlet side of the flow path for oxidant gas, and an area in a flow path for cooling fluid where the temperature of the cooling fluid is low, that is, an inlet side of the flow path for cooling fluid, are formed closely to each other so that these areas substantially correspond to each other, thereby to suppress flooding and provide a stable output voltage. (See Patent Document 1, for example.)

Patent Document 1: Japanese Laid-Open Patent Publication No. Hei 9-511356

### DISCLOSURE OF THE INVENTION

Problem that the Invention is to Solve

However, the separator plate employing the method as proposed in the above described Patent Document 1 has the following problems because the two areas are corresponding to each other: one is the area in the flow path for oxidant gas where the water content is small, that is, an area where the total amount of the water produced by the reaction as represented by the expression (1) is small, the concentration of the oxidant gas is high, and the amount of heat generated as the reaction of the expression (1) proceeds is large; and the other is the section for introducing a cooling fluid.

FIG. 12 shows a top view of the conventional cathode side separator plate having the same configuration as that of the separator plate in the above described Patent Document 1, as viewed from the cooling fluid flow path side. In a conventional separator plate 101, a groove-like flow path 107 for cooling fluid is provided for connecting an inlet side manifold aperture 102a with an outlet side manifold aperture 102b for cooling fluid. On the back face thereof, an inlet side manifold aperture 103a and an outlet side manifold aperture 103b for oxidant gas are connected via a groove-like gas flow path for oxidant gas (not shown). Herein, the reference numerals 104a and 104b indicate an inlet side manifold aperture and an outlet side manifold aperture for fuel gas, respectively. An opening 106 for clamping bolt is provided at each of the four corners.

In an area 108 shown by hatching on the conventional cathode side separator plate 101, the two areas are corresponding to each other: one is the section for introducing a cooling fluid; and the other is the area where the water content in the flow path for oxidant gas is small, the area being located in the vicinity of the inlet side manifold aperture 103a for oxidant gas. Because of this, the cooling fluid in the inlet side manifold for cooling fluid is affected by the heat generation in an area corresponding to the cathode as defined by dash-dotted line 105. Therefore, the temperature T₀ of the cooling fluid before introduction or immediately after introduction to the cell stack is raised to T₁ by the temperature T₂ of the heated cathode (herein, T₀<T₁<T₂). The temperature increase ΔT (=T₁−T₀) is relatively great. The same is true in the anode side separator plate. When this happened, in the inlet side manifold for cooling fluid in a cell stack composed of stacked unit cells, a difference occurs in temperature of the cooling fluid between at the inlet where the residence time of the cooling fluid is short and at the rearmost end from the inlet where the residence time is long (that is, the downstream end of the inlet side manifold for cooling fluid in the flow direction of the cooling fluid). Accordingly, in the stacking direction in the cell stack, the cooling effect is diminished as the cooling fluid flows to the downstream end, and the cooled state varies among respective unit cells. This makes it impossible to achieve an optimum cooled state.

As a result, since the temperature of each unit cell varies in the stacking direction in the cell stack, in a unit cell having a higher temperature, the moisture is evaporated from the polymer electrolyte membrane and the degradation of the polymer electrolyte membrane is accelerated to shorten the durability of the unit cell, or the specific resistance of the polymer electrolyte membrane is increased to lower the output from the unit cell.

On the other hand, in a unit cell having a lower temperature, the moisture contained in the reaction gas that flows in the gas flow path is condensed and the water in a liquid state is increased to cause flooding, a phenomenon in which water attached on the inside of the gas flow path clogs the gas flow path to block the flow of the gas.

Since the problems as described above are caused by uneven cooling of the unit cells in the stacking direction in the cell stack, it is difficult to solve them by optimizing the pattern of the flow path for cooling fluid, or the flow rate of the cooling fluid in the separator plate in the individual unit cell.

The present invention has been achieved in view of the problems above, intending to provide a fuel cell in which flooding is suppressed, and that is excellent in durability and capable of outputting a stable voltage, by way of suppressing the increase in temperature of the cooling fluid in the inlet side manifold during power generation of the fuel cell, the increase resulted from the difference between the temperature of the heat generation section of the unit cell and the temperature of the cooling fluid in the inlet side manifold for cooling fluid, thereby to reduce the variation in temperature among respective unit cells in the stacking direction in the cell stack of the fuel cell.

Means for Solving the Problem

In order to solve the above described problems, the present invention provides a fuel cell comprising a cell stack including two or more stacked unit cells, each of the unit cells comprising a membrane electrode assembly including a polymer electrolyte membrane, a cathode and an anode sandwiching the polymer electrolyte membrane, and a cathode side separator plate and an anode side separator plate sandwiching the membrane electrode assembly, wherein

the cell stack includes-an inlet side manifold and an outlet side manifold of an oxidant gas, an inlet side manifold and an outlet side manifold of a fuel gas, and an inlet side manifold and an outlet side manifold of a cooling fluid,

the cathode side separator plate has an oxidant gas flow path for communicating the inlet side manifold of the oxidant gas and the outlet side manifold of the oxidant gas, the oxidant gas flow path being provided on a first plane opposing the cathode,

the anode side separator plate has a fuel gas flow path for communicating the inlet side manifold of the fuel gas and the outlet side manifold of the fuel gas, the fuel gas flow path being provided on a first plane opposing the anode,

at least one of the cathode side separator plate and the anode side separator plate has a cooling fluid flow path for communicating the inlet side manifold of the cooling fluid and the outlet side manifold of the cooling fluid, the cooling fluid flow path being provided on a second plane located on the opposite side of the first plane, and

the cooling fluid flow path has a first cooling section in which an area corresponding to the cathode and an area corresponding to the anode are cooled, and a second cooling section located between the first cooling section and the inlet side manifold of the cooling fluid.

The “area corresponding to the cathode” as used herein refers to an area that, when the “area corresponding to the cathode” is projected in the direction of normal line of the main plane of the cathode side separator plate (projected to be at equal magnification), has the substantially same size and shape as those of a drawing outlining a gas diffusion layer constituting the cathode, which is a power generation section of the membrane electrode assembly (a drawing that looks like a “gas diffusion layer constituting the cathode” as a result of projection). In other words, it refers to an area that overlaps with the drawing outlining the “gas diffusion layer constituting a cathode” in a state that the area and the drawing substantially correspond to each other (a section indicated with a reference numeral 35 in FIGS. 3 and 4).

On the other hand, the “area corresponding to the anode” as used herein refers to an area that, when the “area corresponding to the anode” is projected in the direction of normal line of the main plane of the anode side separator plate (projected to be at equal magnification), has the substantially same size and shape as those of a drawing outlining a gas diffusion layer constituting the anode, which is a power generation section of the membrane electrode assembly (a drawing that looks like a “gas diffusion layer constituting the anode” as a result of projection). In other words, it refers to an area that overlaps with the drawing outlining the “gas diffusion layer constituting the anode” in a state that the area and the drawing substantially correspond to each other (a section indicated with a reference numeral 45 in FIGS. 5 and 6).

As described above, since in at least one of the cathode side separator plate and the anode side separator plate, in addition to the first cooling section for cooling the areas corresponding to the cathode and the anode (i.e. the cooling section as used in the conventional techniques), the second cooling section is provided between the first cooling section and the inlet side manifold for cooling fluid, it is possible to suppress the increase in temperature of the cooling fluid in the inlet side manifold during power generation of the fuel cell, the increase resulted from the difference between the temperature of the heat generation section (i.e. the anode and the cathode) in the unit cell and the temperature of the cooling fluid in the inlet side manifold for cooling fluid, and reduce the variation in temperature among respective unit cells in the stacking direction in the fuel cell. Thus, it is possible to obtain a fuel cell excellent in durability, in which flooding is suppressed.

### EFFECT OF THE INVENTION

According to the present invention, since the temperature increase of the cooling fluid in the inlet side manifold is suppressed, in the inlet side manifold for cooling fluid in the cell stack, the temperature of the cooling fluid is not increased as the cooling fluid moves from the inlet to the rearmost end and thus the temperature of the cooling fluid at the inlet and that at the rearmost end do not greatly differ. Because of this, there is almost no difference in temperature in the cooling fluid to be introduced into the respective cells of the cell stack, and the whole cell stack is substantially evenly cooled.

Therefore, according to the present invention, since the variation in temperature among respective cells in the cell stack of a fuel cell is reduced, it is possible to provide a fuel cell excellent in durability and capable of outputting a stable voltage, in which flooding is suppressed.

### BRIEF DESCRIPTION OF THE DRAWINGS

FIG. 1. A schematic longitudinal sectional view of a basic configuration (unit cell) of a fuel cell according to a first embodiment 1 of the present invention.

FIG. 2. A perspective view of a cell stack including two or more stacked unit cells as shown in FIG. 1.

FIG. 3. A front view of a cathode side separator plate of the fuel cell as shown in FIG. 1.

FIG. 4. A rear view of the cathode side separator plate as shown in FIG. 3.

FIG. 5. A front view of an anode side separator plate of the fuel cell as shown in FIG. 1.

FIG. 6. A rear view of the anode side separator plate as shown in FIG. 5.

FIG. 7. A front view conceptually showing a temperature profile (distribution) of cooling water in the cathode side separator plate used for the fuel cell according to the first embodiment of the present invention.

FIG. 8. A rear view of a cathode side separator plate according to a second embodiment of the present invention.

FIG. 9. A rear view of an anode side separator plate according to the second embodiment of the present invention.

FIG. 10. A rear view of a cathode side separator plate according to a comparative example.

FIG. 11. A rear view of an anode side separator plate according to the comparative example.

FIG. 12. A front view conceptually showing a temperature profile (distribution) of cooling water in the cathode side separator plate used for a fuel cell according to the comparative example.

### BEST MODE FOR CARRYING OUT THE INVENTION

Hereinafter, preferred embodiments for carrying out the present invention will be described with reference to the drawings. It should be noted that in the descriptions below, identical or corresponding sections are denoted by the same reference numeral and the repetitive descriptions thereof may be omitted.

### First Embodiment

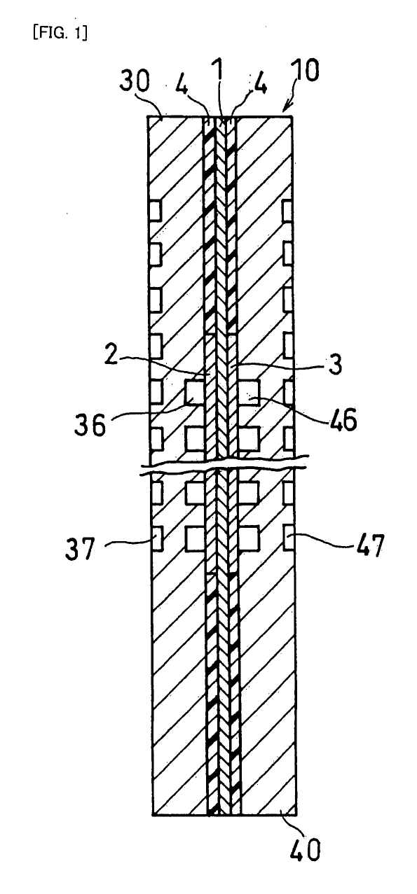

FIG. 1 is a schematic sectional view of a basic configuration of a fuel cell according to a first embodiment of the present invention. A unit cell 10 includes a polymer electrolyte membrane 1 having hydrogen ion conductivity, which is an example of polymer electrolyte membranes, and a cathode 2 and an anode 3 sandwiching the polymer electrolyte membrane 1. For the polymer electrolyte membrane 1, a membrane containing perfluorosulfonic acid (Nafion (trade name) manufactured by E. I. du Pont de Nemours and Company) is used. The cathode and the anode each comprises a catalyst layer disposed in contact with the polymer electrolyte membrane and a gas diffusion layer disposed outside the catalyst layer. For a catalyst in the cathode and the anode, a carbon carrying an electrode catalyst (for example, platinum metal) is used.

The unit cell 10 includes a cathode side separator plate 30 and an anode side separator plate 40 sandwiching a membrane electrode assembly (MEA) composed of the polymer electrolyte membrane 1, the cathode 2 and the anode 3. The polymer electrolyte membrane 1 is sandwiched by gaskets 4 in the peripheries of the cathode 2 and the anode 3. In the descriptions below, the unit cell 10 is positioned in such a manner that the MEA stands perpendicular to the horizontal direction as shown in FIG. 1.

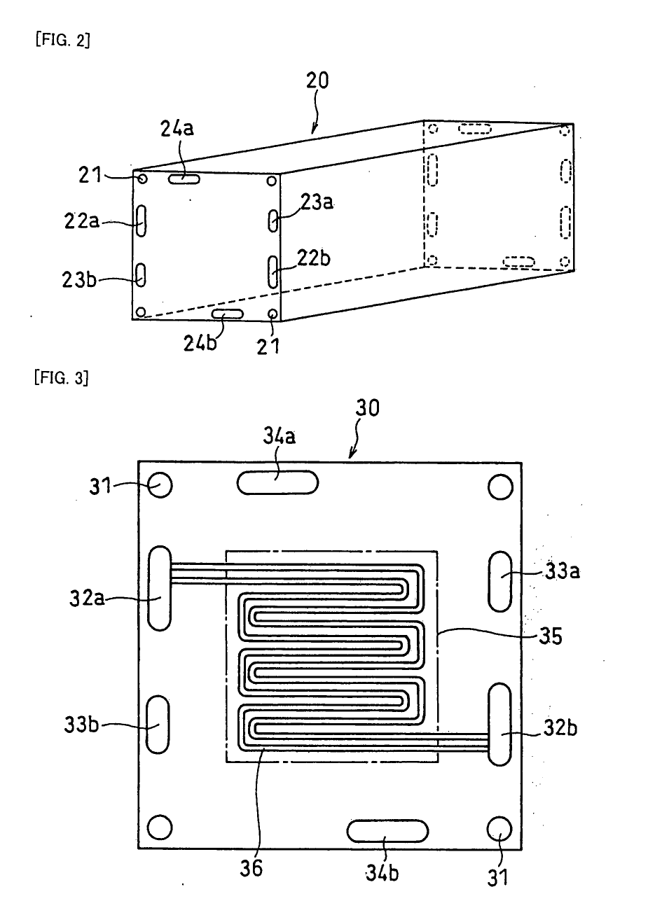

Next, FIG. 2 is a schematic perspective view of a cell stack obtained by stacking two or more (plural) unit cells 10 as described above. A cell stack 20 includes an oxidant gas inlet 22a connected with inlet side manifold apertures for oxidant gas, an oxidant gas outlet 22b connected with outlet side manifold apertures for oxidant gas; a fuel gas inlet 23a connected with inlet side manifold apertures for fuel gas, a fuel gas outlet 23b connected with outlet side manifold apertures for fuel gas; and a cooling water inlet 24a connected with inlet side manifold apertures for cooling water, a cooling water outlet 24b connected with outlet side manifold apertures for cooling water, the inlet side manifold apertures communicating with each other and the outlet side manifold apertures communicating with each other for each of oxidant gas, fuel gas and cooling water being provided on the MEA, the cathode side separator plate 30 and the anode side separator plate 40. Herein, the separator plates arranged on both ends of the cell stack 20 are not provided with a flow path for cooling water. An end plate is disposed on each end of the cell stack 20 with a current collector plate and an insulating plate interposed therebetween, and the whole is fastened with clamping bolts to fabricate a fuel cell.

In the fuel cell configured as described above, an oxidant gas introduced into the inlet side manifold of each cell from the oxidant gas inlet 22a flows into a flow path 36 in the cathode side separator plate 30 and diffuses through the gas diffusion electrode of the cathode 12, to be used for reaction. Excess oxidant gas and reaction products are discharged from the outlet 22b via the flow path 36 and the outlet side manifold. Similarly, a fuel gas is supplied to the anode 3 via the inlet 23a, the inlet side manifold, and a flow path 46 in the anode side separator plate 40, and excess fuel gas and reaction products are discharged from the outlet 23a via the flow path 46 and the outlet side manifold.

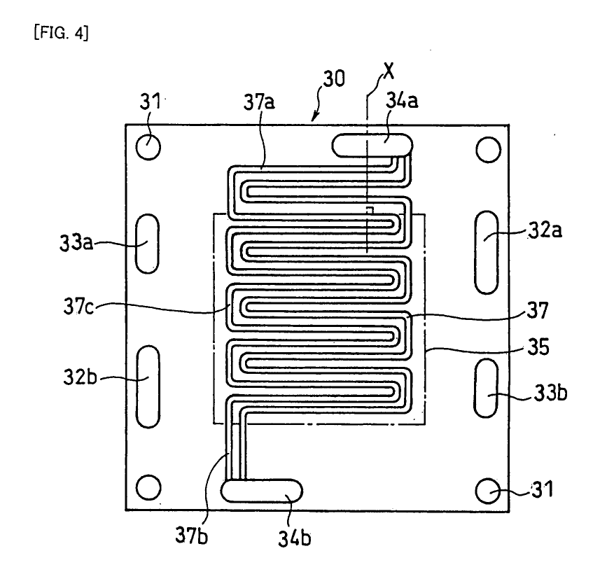

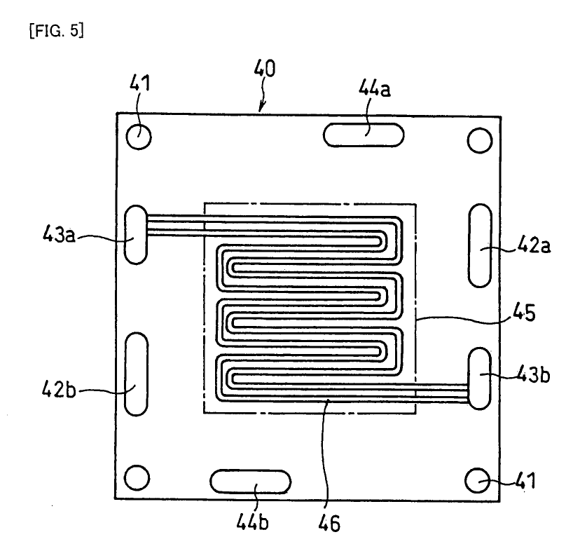

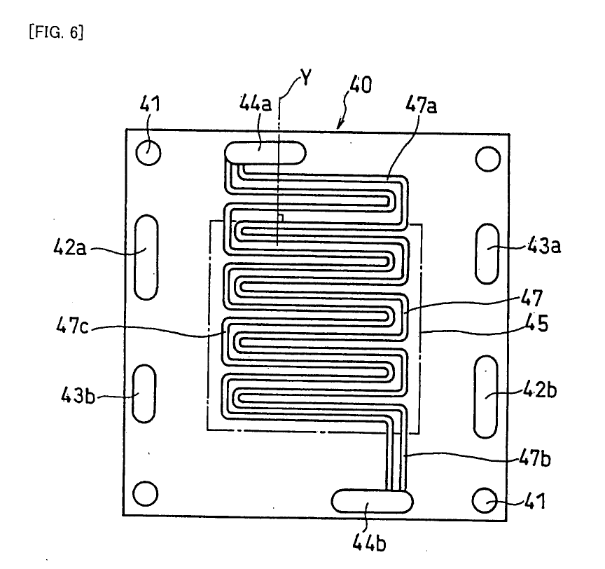

In the conventional fuel cell, as described above, there is a problem in that the cooling water in the inlet side manifold for cooling water is affected by heat generation of the electrodes, and thus the temperatures of the unit cells become uneven in the stacking direction in the cell stack. Therefore, in a unit cell having a higher temperature, the moisture is evaporated from the polymer electrolyte membrane and the degradation of the polymer electrolyte membrane is accelerated to shorten the durability of the unit cell, or the specific resistance of the polymer electrolyte membrane is increased to lower the output from the unit cell. In order to solve this problem, the fuel cell according to the present invention uses the cathode side separator plate having a configuration as shown in FIG. 3 and FIG. 4, and the anode side separator plate having a configuration as shown in FIG. 5 and FIG. 6.

FIG. 3 is a front view as viewed from the oxidant gas flow path side of the cathode side separator plate of a fuel cell according to the present embodiment. FIG. 4 is a rear view of the cathode side separator plate as shown in FIG. 3, that is, a front view as viewed from the cooling water flow path side.

As shown in FIG. 3 and FIG. 4, the cathode side separator plate 30 includes an inlet side manifold aperture 32a for oxidant gas and an outlet side manifold aperture 32b for oxidant gas; an inlet side manifold aperture 33a for fuel gas and an outlet side manifold aperture 33b for fuel gas; an inlet side manifold aperture 34a for cooling water and an outlet side manifold aperture 34b for cooling water; and four openings 31 to each of which a clamping bolt is inserted. The cathode side separator plate 30 has the flow path 36 for oxidant gas for connecting the manifold apertures 32a with 32b for oxidant gas on the face opposing to the cathode, and on the back face, has a flow path 37 for cooling water for connecting the manifold apertures 34a with 34b for cooling water.

In FIG. 3 and FIG. 4, an area defined by dash-dotted line 35 is an area corresponding to the cathode. Specifically, in FIG. 3, the area defined by dash-dotted line 35 is in contact with a gas diffusion layer constituting the cathode, which is a power generation section of the MEA. This corresponds to an area where the power generation section including a catalyst layer of the MEA is located. Further, as shown in FIG. 3, the flow path 36 for oxidant gas is composed of two grooves running in parallel. In the area defined by dash-dotted line 35, each groove includes seven straight portions extending in horizontal direction and six turning portions connecting adjacent straight portions. The number of groove and the number of turning portion are not limited to these and they may be set to any number within the scope that does not impair the effect of the present invention.

On the other hand, the flow path 37 for cooling water is composed of two groves running in parallel, and includes a section 37c located in the area defined by dash-dotted line 35, an inlet section 37a (a second cooling section) for connecting the section 37c with the inlet side manifold aperture 34a, and an outlet section 37b for connecting the section 37c (a first cooling section) with the outlet side manifold aperture 34b. In the section 37c, one groove includes seven straight portions extending in horizontal direction and six turning portions connecting adjacent straight portions, and the other groove additionally includes one straight portion and one turning portion.

In other words, as shown in FIG. 4, assuming that the inlet side manifold aperture 34a for cooling water and the area corresponding to the cathode as defined by dash-dotted line 35 are connected at a shortest distance with a line X, the second cooling section 37a is composed of at least one groove extending substantially perpendicular to the line X.

The outlet section 37b is composed of straight portions extending simply in vertical direction; and the inlet section 37a is composed of a groove including one straight portion extending in horizontal direction and one turning portion, and a groove including two straight portions extending in horizontal direction and one turning portion. In this case also, the number of groove and the number of turning portion are not limited to these and they may be set to any number within the scope that does not impair the effect of the present invention.

As described above, according to the present embodiment, in the flow path 37 for cooling water, the inlet section 37a differs from the outlet section 37b in that the inlet section 37a has three straight portions extending in horizontal direction and this enables effective cooling on the separator plate. Moreover, in the area defined by dash-dotted line 35, that is, the section 37c, the grooves are arranged substantially in correspondence to those in the same section of the flow path for oxidant gas except that one straight portion extending in horizontal direction is additionally included.

Herein, it is preferable that the first cooling section 37c is formed within the scope that does not cool the inlet side manifold aperture 32a for oxidant gas and the inlet side manifold aperture 33a for fuel gas. Therefore, for example, the first cooling section 37c may go beyond the above described area defined by dash-dotted line 35 as long as the section will not excessively cool the inlet side manifold aperture 32a for oxidant gas and the inlet side manifold aperture 33a for fuel gas. However, as shown in FIG. 4, in order to secure cooling, it is preferable that the first cooling section 37c does not go beyond the above described area defined by dash-dotted line 35.

On the other hand, the outlet side manifold aperture 32b for oxidant gas and the outlet side manifold aperture 33b for fuel gas located in the downstream of the flow path 37 for cooling water are relatively more cooled than the inlet side manifold aperture 32a for oxidant gas and the inlet side manifold aperture 33a for fuel gas. For this reason, the first cooling section 37c may or may not go beyond the above described area defined by dash-dotted line 35 in the vicinity of the inlet side manifold aperture 32a for oxidant gas and the inlet side manifold aperture 33a for fuel gas.

Next, FIG. 5 is a front view of the anode side separator plate of the fuel cell according to the present embodiment as viewed from the fuel gas flow path side. FIG. 6 is a rear view of the anode side separator plate as shown in FIG. 5, that is, a front view as viewed from the cooling water flow path side.

As shown in FIG. 5 and FIG. 6, the anode side separator plate 40 includes an inlet side manifold aperture 42a for oxidant gas and an outlet side manifold aperture 42b for oxidant gas; an inlet side manifold aperture 43a for fuel gas and an outlet side manifold aperture 43b for fuel gas; an inlet side manifold aperture 44a for cooling water and an outlet side manifold aperture 44b for cooling water; and four openings 41 to each of which a clamping bolt is inserted. The anode side separator plate 40 has the flow path 46 for fuel gas for connecting the manifold apertures 43a with 43b for fuel gas on the face opposing to the anode, and on the back face, has a flow path 47 for cooling water for connecting the manifold apertures 44a with 44b for cooling water.

In FIG. 5 and FIG. 6, an area defined by dash-dotted line 45 is an area corresponding to the anode, similarly to the case of the cathode side separator plate as shown in FIG. 3 and FIG. 4. Specifically, in FIG. 5, the area defined by dash-dotted line 45 is in contact with a gas diffusion layer constituting the anode, which is a power generation section of the MEA. Further, as shown in FIG. 5, the flow path 46 for fuel gas is composed of two grooves running in parallel. In the area defined by dash-dotted line 45, each groove includes seven straight portions extending in horizontal direction and six turning portions connecting adjacent straight portions. The number of groove and the number of turning-portion are not limited to these and they may be set to any number within the scope that does not impair the effect of the present invention.

The anode side separator plate 40 has a flow path 47 for cooling water, which forms a conduit for cooling water in combination with the flow path 37 for cooling water in the separator plate 30 when the rear face of the anode side separator plate 40 is bonded with the rear face of the cathode side separator plate 30. The flow path 47 therefore has a shape symmetrical to the flow path 37 with respect to a plane. Accordingly, the configuration of the flow path 47 may be changed depending on the configuration of the flow path 37.

The flow path 47 includes a section 47c (a first cooling section) located in the area defined by dash-dotted line 45, an inlet section 47a (a second cooling section) for connecting the section 47c with the inlet side manifold aperture 44a, and an outlet section 47b for connecting the section 47c with the outlet side manifold aperture 44b.

Further, as shown in FIG. 6, assuming that the inlet side manifold aperture 44a for cooling water and the area corresponding to the anode as defined by dash-dotted line 45 are connected at a shortest distance with a line Y, the second cooling section 47a is composed of at least one groove extending substantially perpendicular to the line Y.

Herein, it is preferable that the first cooling section 47c is formed within the scope that does not cool the inlet side manifold aperture 42a for oxidant gas and the inlet side manifold aperture 43a for fuel gas. Therefore, for example, the first cooling section 47c may go beyond the above described area defined by dash-dotted line 45 as long as the section will not excessively cool the inlet side manifold aperture 42a for oxidant gas and the inlet side manifold aperture 43a for fuel gas. However, as shown in FIG. 6, in order to secure cooling, it is preferable that the first cooling section 47c does not go beyond the above described area defined by dash-dotted line 45.

On the other hand, the outlet side manifold aperture 42b for oxidant gas and the outlet side manifold aperture 43b for fuel gas located in the downstream of the flow path 47 for cooling water are relatively more cooled than the inlet side manifold aperture 42a for oxidant gas and the inlet side manifold aperture 43a for fuel gas. For this reason, the first cooling section 47c may or may not go beyond the above described area defined by dash-dotted line 35 in the vicinity of the inlet side manifold aperture 42a for oxidant gas and the inlet side manifold aperture 43a for fuel gas.

Hereinafter, descriptions will be made about a mechanism in which the conventional problems as described above are solved by the separator plate included in the fuel cell according to the present embodiment, with reference to the cathode side separator plate 30 as shown in FIG. 3 and FIG. 4.

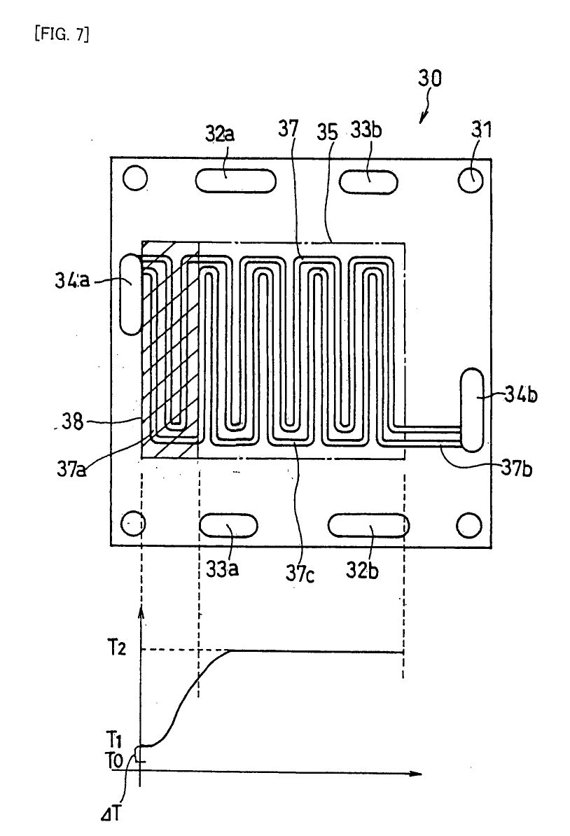

FIG. 7 is a graph conceptually showing a temperature profile (distribution) of cooling water flowing through the flow path 37 for cooling water in the cathode side separator plate 30 of the fuel cell according to the present invention as shown in FIG. 4.

In the cathode side separator plate 30 according to the present invention, in addition to the first cooling section 37c located in the area corresponding to the cathode as defined by dash-dotted line 35, the second cooling section 37a located in an area 38 indicated by hatching between the first cooling section 37c and the inlet side manifold 34a for cooling water is provided. In the conventional separator plate, the cooling water in the inlet side manifold for cooling water is affected by heat generation of the cathode in the area corresponding to the cathode as defined by dash-dotted line 35. In contrast, in the separator 30 according to the present invention, since the second cooling section 37a is provided, the temperature T₀ of the cooling water before introduction or immediately after introduction to the cell stack 20 rises to T₁, by the temperature T₂ of the heated cathode (herein, T₀<T₁<T₂); however the temperature increase ΔT (=T₁−T₀) is smaller than that in the conventional separator plate.

As a result, in the inlet side manifold for cooling water in the cell stack 20 composed of the stacked unit cells 10, it is possible to reduce the difference in temperature of the cooling water that occurs between at the inlet where the residence time of the cooling water is short and at the rearmost end from the inlet where the residence time is long (that is, the downstream end of the inlet side manifold for cooling water in the flow direction of the cooling water). Accordingly, it is possible to suppress the variation in the cooled state from occurring among respective unit cells 10 in the cell stack 20 in the stacking direction, and achieve an optimum cooled state.

Specifically, in the fuel cell of the present invention, as a temperature increase suppressing means for suppressing the increase in temperature of the cooling water in the inlet side manifold, the increase being resulted from the difference in temperature between the heat generation section of the unit cell 10 and the cooling water in the inlet side manifold for cooling water during power generation, the second cooling section 37a is disposed between the first cooling section 37c for cooling with cooling water the area corresponding to the heat generation section of the unit cell as defined by dash-dotted line 35, and the inlet side manifold aperture 34a for cooling water, in the separator plate in the each unit cell 10. The second cooling section 37a thus disposed cools the area 38 in the separator plate located between the first cooling section 37c and the inlet side manifold aperture 34a for cooling water. This makes it possible to suppress the variation in the cooled state from occurring among respective unit cells 10 in the stacking direction in the cell stack 20, and achieve an optimum cooled state.

In the cell stack 20 of the fuel cell according to the present embodiment thus configured, the cooling water is introduced from the inlet 24a, flows from the inlet side manifold through conduits each formed of the flow path 37 in the cathode side separator plate 30 and the flow path 47 in the anode side separator plate 40, and is discharged from the outlet 24b via the outlet side manifold. The discharged cooling water is subjected to heat exchange in an appropriate heat exchanger and then introduced into the cell stack 20 from the inlet 24a again. The cooling water flowing through the conduits each formed of the flow paths in the separator plates 30 and 40 cools the sections corresponding to the catalyst layers of the cathodes and the anodes serving as heat generation sections of the unit cells 10, in the first cooling sections composed of the sections 37c of the separator plates 30 and the sections 47c of the separator plates 40. And in the second cooling sections composed of the sections 37a of the separator plates 30 and the sections 47a of the separator plates 40, the cooling water cools the sections each located between the first cooling section and the inlet side manifold in the separator plate. With this configuration, it is possible to suppress the increase in temperature of the cooling water flowing through the inlet side manifold formed of the separator plates 30 and 40, the increase caused by heat in the heat generation section in the unit cells 10.

### Second Embodiment.

Next, a second embodiment of the fuel cell according to the present invention will be described. A fuel cell according to the second embodiment (not shown) is a variation on the fuel cell according to the first embodiment as shown in FIG. 1 with respect to the separator plates 30 and 40 in the unit cell 10. It is configured in the same manner as the unit cell 10 of the first embodiment except the separator plates 30 and 40.

Hereinafter, descriptions will be made about the separator plates to be provided in the fuel cell according to the second embodiment (the second embodiment of the separator plate of the present invention).

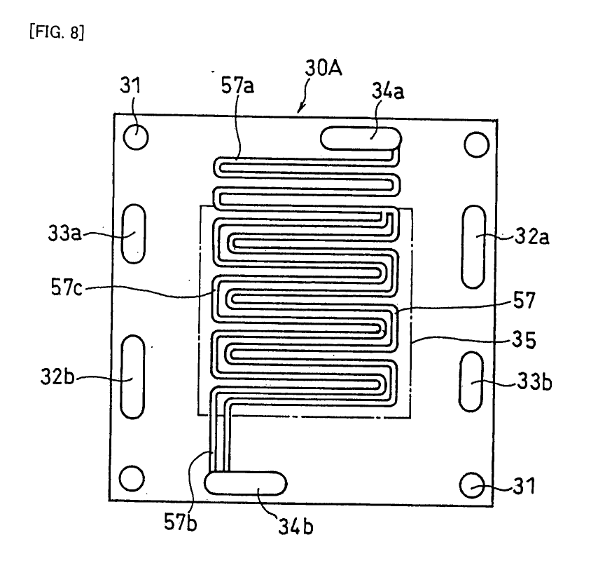

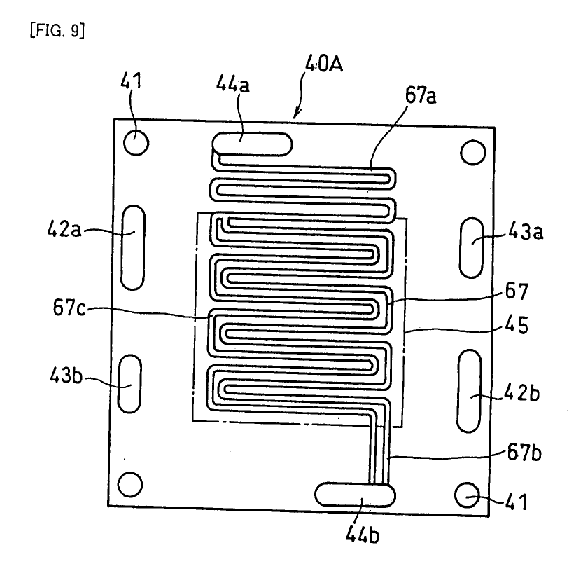

The fuel cell of the present embodiment is configured in the same manner as that of the above described first embodiment except that the shape of the flow path for cooling water in the cathode side separator plate is as shown in FIG. 8 and the shape of the flow path for cooling water in the anode side separator plate is as shown in FIG. 9.

A flow path 57 for cooling water in the cathode side separator plate 30A is composed of an inlet section 57a (a second cooling section) connected with the inlet side manifold aperture 34a, a section 57c (a first cooling section) on an area defined by dash-dotted line 35 and an outlet section 57b connected with the outlet side manifold aperture 34b.

The inlet section 57a is not identical with the section 37a of the first embodiment in that the section 57a is composed of one groove; however the groove includes three straight portions and two turning portions, and the total length thereof is substantially the same as that of the groove in the section 37a. The section 57c on an area defined by dash-dotted line 35 is substantially identical with the section 37c of the first embodiment except that the groove in the section 57c is provided with a branch in the vicinity of the turning portion in the downstream of the uppermost straight line of the section 57c, the uppermost straight line being connected with the section 57a. The outlet section 57b includes straight portions running in vertical direction for connecting the section 57c to the manifold aperture 34b as in the case of the first embodiment.

A flow path 67 for cooling water of an anode side separator plate 40A has a shape symmetrical to the flow path 57 with respect to a plane. In other words, the flow path 67 includes a section 67c (a first cooling section) located in an area defined by dash-dotted line 45, an inlet section 67a (a second cooling section) for connecting the section 67c with the inlet side manifold aperture 44a, and an outlet section 67b for connecting the section 67c with the outlet side manifold aperture 44b.

In contrast to the configuration of the first cooling section that is composed of two flow paths, the second cooling section is composed of one flow path. Therefore, the flow rate of the cooling water in the second cooling section is twice as fast as that of the cooling water in the first cooling section, whereby a more favorable cooling effect can be obtained.

Although the embodiments of the present invention have been described in detail, it is to be understood that the present invention is not limited to the above described embodiments.

For example, in the above described embodiments, the cooling section composed of the conduit for cooling water is provided between the each unit cells; however, the cooling section may be disposed every two or three unit cells, for example. Moreover, for the conduit for cooling water, grooves are provided in both the cathode side separator plate and the anode side separator to form a pair of flow paths; however grooves may be provide only in one of the separator plates to dispose the conduit for cooling water between the separator plates.

Further, according to the above described embodiment, in the cell stack 20 composed of stacked unit cells, the conduit for cooling water is formed between the cathode side separator plate and the anode side separator plate; however, with respect to the cathode side separator plate or the anode side separator plate located on the outside of the unit cells at both ends of the cell stack 20a, since a current collector plate, an insulating plate and an end plate are stacked on each of the separator plates, the conduit for cooling water may be formed between the separator plate and the current collector plate.

Further, the conduit for cooling water in the separator plate is communicated with the inlet side manifold and the outlet side manifold for cooling water, and is typically composed of a single groove or a plurality of grooves provided in the separator plate. In the case where the first cooling section is composed of two or more grooves, the second cooling section may be composed of the same number of grooves as the first cooling section. Alternatively, the second cooling section may be composed of a smaller number of grooves than the first cooling section.

With such a configuration as described above, it is possible to provide cooling water to the first cooling section while the amount of heat exchange in the second cooling section is suppressed to some extent, and thus the cooling effect on the heat generation section achieved by virtue of the first section can be sufficiently exerted. This makes it possible to effectively suppress an increase in temperature of the cooling water in the inlet side manifold.

It should be noted that in contrast to the configuration of the separator plate, other components are not limited and may be appropriately selected within the scope that does not impair the effect of the present invention. The cooling fluid is not limited to the cooling water.

### EXAMPLES

The present invention will be hereinafter described in detail with reference to Examples and Comparative Examples, but the present invention is not limited to these Examples.

### Example 1

First, a gas diffusion layer was fabricated. A carbon cloth in which the diameter of 80% or more pores was 20 to 70 μm (GF-20-E) manufactured by Nippon Carbon Co., Ltd. was used as a base material and immersed in an aqueous dispersion obtained by dispersing polytetrafluoroethylene (PTFE) in pure water including a surfactant. Thereafter, the base material was passed through a far-infrared dryer to be baked at 300° C. for 60 minutes. Herein, the content of water-repellent resin (PTFE) in the base material was 1.0 mg/cm².

Thereafter, slurry for coating layer was prepared. Carbon black was added to a solution obtained by mixing pure water and surfactant, and then dispersed-for three hours with a planetary mixer. To the dispersion thus obtained, PTFE and water were added and kneaded for three hours. Herein, for the surfactant, a surfactant commercially available under the trade name of Triton X-100 was used.

The slurry for coating layer was applied on one face of the carbon cloth subjected to water-repellent treatment as described above, with an applicator. The carbon cloth with a coating layer formed thereon was baked at 300° C. for two hours by a dryer to fabricate a gas diffusion layer. The content of water-repellent resin (PTFE) in the gas diffusion layer thus fabricated was 0.8 mg/cm².

Secondary, a catalyst layer was fabricated. Platinum as an electrode catalyst was allowed to be carried on Ketjen Black (Ketjen Black EC manufactured by Ketjen Black International Company, particle size: 30 nm) as carbon powder to obtain a catalyst body. 66 parts by mass of the catalyst body thus obtained (including 50% by mass of platinum) was mixed with 33 parts by mass (polymer dry mass) of perfluorocarbon sulfonic acid ionomer (dispersion containing 5% by mass of Nafion manufactured by Aldrich Chemical Co., Inc., U.S.A.) as a hydrogen ion conductive material and a binder. The mixture thus obtained was formed into a catalyst layer (10 to 20 μm).

The gas diffusion layer and the catalyst layer obtained as described above were bonded on both faces of a polymer electrolyte membrane (Nafion 112 membrane manufactured by E. I. du Pont de Nemours and Company, ion exchange capacity: 0.9 meq/g) by hot pressing to fabricate an MEA.

Thereafter, on the peripheries of the MEA thus fabricated, rubber gasket plates were bonded and then manifold apertures for allowing a fuel gas and an oxidant gas to pass therethough were formed.

On the other hand, a cathode side separator plate configured as shown in FIG. 3 and FIG. 4, and an anode side separator plate configured as shown in FIG. 5 and FIG. 6, which have outer dimensions of 160 mm×160 mm×5 mm and a gas flow path of 1.0 mm in width and 1.0 mm in depth and are composed of a graphite plate with phenol resin immersed therein were prepared.

These separator plates were combined with the MEA in such a manner that the cathode side separator plate with a gas flow path for oxidant gas formed thereon was bonded on one face of the MEA, and the anode side separator plate with a gas flow path for fuel gas formed thereon was bonded on the other face of the MEA, whereby a unit cell was obtained.

Thereafter, 100 unit cells were stacked to give a cell stack. On each end of the cell stack, a current collector plate made of cupper and an insulating plate made of an electric insulating material and an end plate were disposed, and then the whole was fastened by clamping rods to fabricate a fuel cell 1 according to the first embodiment of the present invention. Herein, the clamping pressure per area of the separator was 10 kgf/cm².

### Example 2

A fuel cell 2 according to the second embodiment of the present invention was fabricated in the same manner as in Example 1 except that the shape of the flow path for cooling water in the cathode side separator plate was configured as shown in FIG. 8 and the shape of the flow path for cooling water in the anode side separator plate was configured as shown in FIG. 9.

### Comparative Example 1

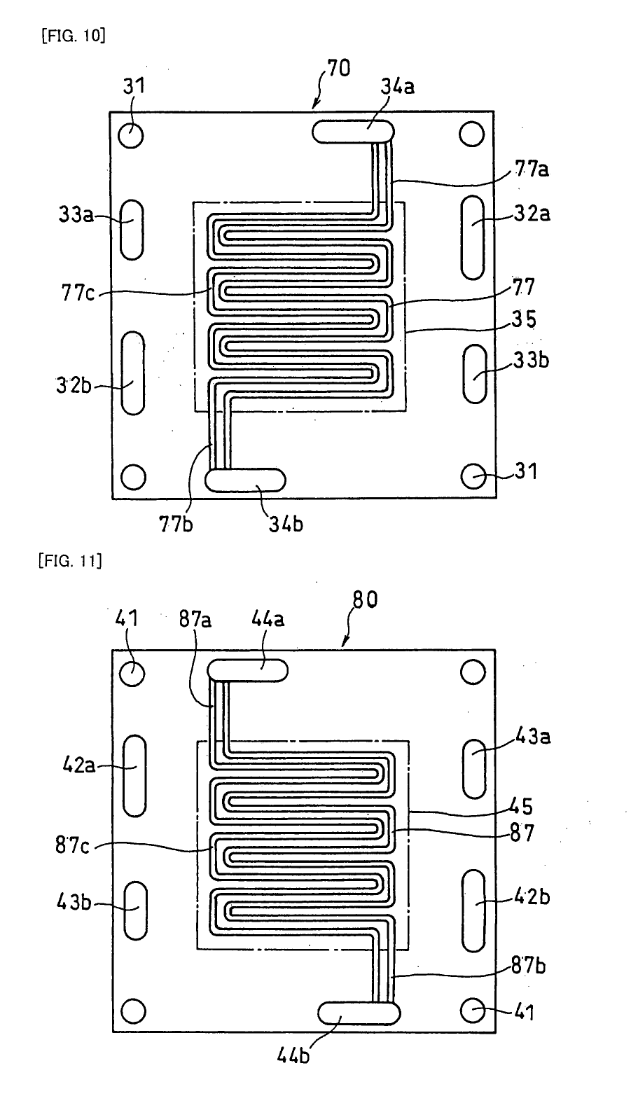

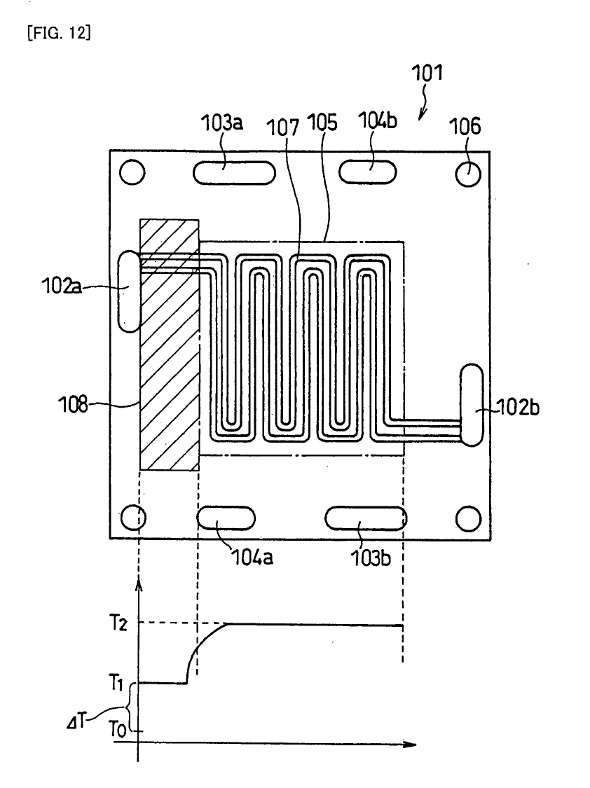

A comparative fuel cell 1 according to the present invention was fabricated in the same manner as in Example 1 except that the shape of the flow path for cooling water in the cathode side separator plate was configured as shown in FIG. 10 and the shape of the flow path for cooling water in the anode side separator plate was configured as shown in FIG. 11.

Herein, a cathode side separator plate 70 and an anode side separator plate 80 had the same configurations as those of the cathode side separator plate 30 and the anode side separator plate 40 of the first embodiment of the present invention, respectively, except for the shape of the flow path for cooling water.

A flow path 77 for cooling water in the cathode side separator plate 70 included an inlet section 77a connected with the inlet side manifold aperture 34a, a section 77c located in the area defined by dash-dotted line 35, and an outlet section 77b connected with the outlet side manifold aperture 34b. The section 77c had the same configuration as that of the flow path 37c of the first embodiment of the present invention. Further the sections 77a and 77b were composed of straight portions running in vertical direction that connect the section 77c and the manifold apertures 34a, and the section 77c and the manifold apertures 34b, respectively.

A flow path 87 for cooling water in the anode side separator plate 80 had a shape symmetrical to the flow path 77 with respect to a plane. Specifically, the flow path 87 included a section 87c located in the area defined by dash-dotted line 45, an inlet section 87a for connecting the section 87c with the inlet side manifold aperture 44a, and an outlet section 87b for connecting the section 87c with the outlet side manifold aperture 44b.

[Evaluation]

With respect to each fuel cell of Examples 1 and 2 and Comparative Example 1 as described above, cooling water having a temperature of 70° C. was supplied to the inlet of the inlet side manifold at a rate of 3.7 liters/min. Hydrogen gas and air heated and humidified until each of them had a dew point of 70° C. were supplied to the anode and the cathode, respectively. Herein the fuel gas utilization rate Uf was set to 70% and the oxidant gas utilization rate Uo was set to 40%.

After the fuel cell was operated at a current density of 0.2 A/cm² for 24 hours, the temperatures of cooling water at the inlet and at the rearmost end from the inlet in the inlet side manifold were measured.

Subsequently, Uo was raised to 70% and operation was performed for six hours to sample a voltage every ten seconds. The standard deviation of the sampled voltages was used to compare the stability in voltage.

Then, Uo was decreased back to 40% and the fuel cell was operated for 24 hours. Starting from this point, a 1000 hour continuous operation was performed. The reduction in mean voltage resulted from this continuous operation was used to compare the durability of the fuel cell.

These results are shown in Table 1.

TABLE 1

| | | | Com. |
|---|---|---|---|
| | Ex. 1 | Ex. 2 | Ex. 1 |
| Temperature of cooling water in | | | |
| manifold (° C.) | | | |
| Inlet | 70 | 70 | 70 |
| Rearmost end | 71 | 70 | 74 |
| Standard deviation of mean voltage | 0.3 | 0.1 | 2.0 |
| during operation at U₀ = 70% σ(mV) | | | |
| Reduction in mean voltage after 1000 | 2.0 | 0.5 | 10.0 |
| hour continuous operation (mV) | | | |
| Temperature of cooling water in the | | | |
| 100th cell (° C.) | | | |
| In the inlet side manifold | 71 | 70 | 74 |
| In the first cooling section | 76 | 75 | 79 |

As is evident from Table 1, in the fuel cell of Comparative Example 1, the temperatures of cooling water in the inlet side manifold for cooling water differ by 4° C. between at the inlet and at the rearmost end from the inlet; and the stability in voltage during operation at a utilization rate of 70% and the durability after the 1000 hour continuous operation were inferior to those of Examples 1 and 2.

It is understood that in the fuel cell of Comparative Example 1, because of the unevenness of the temperature of the cooling water in the manifold, it is difficult to optimally cool each cell in the cell stack. In other words, it is conceivable that the temperature of the unit cell was increased as a result of insufficient cooling and the moisture was evaporated from the polymer electrolyte membrane. This accelerated the degradation of the polymer electrolyte membrane, shortened the durability of the unit cell, increased the specific resistance of the polymer electrolyte membrane, and lowered the output from the unit cell.

In contrast, in the fuel cell of the present invention, since the temperature increase suppressing means for suppressing the increase in temperature of cooling water caused by the difference between the temperature of the heat generation section of the MEA during power generation and the temperature of the cooling water in the inlet side manifold for cooling water was provided, the occurrence of the problems as described above was not observed. This confirmed the effect of preventing the degradation in durability of the fuel cell.

In the fuel cell of Example 2, as is evident from Table 1, the temperatures of cooling water in the inlet side manifold for cooling water do not differ between at the inlet and at the rearmost end from the inlet; and the stability in voltage during operation at a utilization rate of 70% and the durability after the 1000 hour continuous operation were superior to those of Example 1.

Presumably, the reason for this is as follows. Since the second cooling section was composed of a smaller number of flow paths than the first cooling section, the flow rate of the cooling water in the second cooling section was faster than that of the first cooling section, whereby a more favorable cooling effect was obtained. This reduced the difference between the temperature of the heat generation section of the unit cell during power generation and the temperature of the cooling water in the inlet side manifold for cooling water, and suppressed the increase in temperature of the cooling water in the inlet side manifold for cooling water. As a result, the effect of suppressing the flooding and the degradation in durability was obtained.

However, it should be understood that the present invention is not limited to the shapes and the numbers of the flow path for cooling water as described in Examples, and many variations may be made while remaining within the spirit and scope of the invention.

Moreover, although each Example relates to a polymer electrolyte fuel cell, the present invention can exert a significant effect when applied to a fuel cell that generates heat due to electrochemical reaction during power generation of the fuel cell and thus needs to be cooled, or a fuel cell that produces water as a reaction product in the cathode.

### INDUSTRIAL APPLICABILITY

The fuel cell according to the present invention has a reduced variation in temperature among the unit cells in the cell stack, is excellent in durability, and does not cause the flooding or the fluctuation in output voltage. Hence, the fuel cell according to the present invention is preferably applicable for domestic cogeneration systems, motor cycles, electric cars, hybrid electric cars, and the like.

1. A fuel cell comprising a cell stack including two or more stacked unit cells, each of said unit cells comprising a membrane electrode assembly comprising a polymer electrolyte membrane, a cathode and an anode sandwiching said polymer electrolyte membrane, and a cathode side separator plate and an anode side separator plate sandwiching said membrane electrode assembly, wherein
said cell stack includes an inlet side manifold and an outlet side manifold of an oxidant gas, an inlet side manifold and an outlet side manifold of a fuel gas, and an inlet side manifold and an outlet side manifold of a cooling fluid,
said cathode side separator plate has an oxidant gas flow path for communicating said inlet side manifold of said oxidant gas and said outlet side manifold of said oxidant gas, said oxidant gas flow path being provided on a first plane opposing said cathode,
said anode side separator plate has a fuel gas flow path for communicating said inlet side manifold of said fuel gas and said outlet side manifold of said fuel gas, said fuel gas flow path being provided on a first plane opposing said anode,
at least one of said cathode side separator plate and said anode side separator plate has a cooling fluid flow path for communicating said inlet side manifold of said cooling fluid and said outlet side manifold of said cooling fluid, said cooling fluid flow path being provided on a second plane located on the opposite side of said first planet,
said cooling fluid flow path has a first cooling section in which an area corresponding to said cathode and an area corresponding to said anode are cooled, and a second cooling section located between said first cooling section and said inlet side manifold of said cooling fluid, and
said second cooling section includes a plurality of grooves having a straight portion and a turning portion the plurality of grooves extending substantially perpendicular to an assumed line connecting said inlet side manifold of said cooling fluid with the area corresponding to said cathode and the area corresponding to said anode at a shortest distance.

2. (canceled)

3. The fuel cell in accordance with claim 1, wherein said first cooling section includes a plurality of grooves parallel to each other and said second cooling section includes a smaller number of grooves than said first cooling section.
